(19) United States
(12) Patent Application Publication
(10) Pub. No.: US 2020/0327069 A1
(43) Pub. Date: Oct. 15, 2020

(54) DATA STORAGE DEVICE AND OPERATION METHOD THEREOF, CONTROLLER USING THE SAME

(71) Applicant: SK hynix Inc., Gyeonggi-do (KR)

(72) Inventors: Hye Mi KANG, Gyeonggi-do (KR); Eu Joon BYUN, Gyeonggi-do (KR)

(21) Appl. No.: 16/662,978

(22) Filed: Oct. 24, 2019

(30) Foreign Application Priority Data
Apr. 15, 2019 (KR) 10-2019-0043618

(51) Int. Cl. G06F 12/12; G06F 12/02

(52) U.S. Cl. CPC G06F 12/12; G06F 2212/1044; G06F 2212/1024; G06F 12/0253

(57) ABSTRACT

In one embodiment of the present disclosure, a data storage device may include: a storage including a plurality of memory blocks, which are divided into a first region configured to operate at a first speed and a second region configured to operate at a lower speed than the first speed; and a controller configured to control the storage, wherein the controller is configured to store information between a plurality of urgency levels, which are defined to classify the storage based on an urgency level determination reference, and a plurality of buffer block groups respectively, being classified on a basis of a number of valid pages included in each of memory blocks within the first region; select a victim block from a buffer block group matched to a current urgency level of the storage; and collect the victim block.

### CROSS-REFERENCE TO RELATED APPLICATION

The present application claims priority under 35 U.S.C. § 119(a) to Korean application number 10-2019-0043618, filed on Apr. 15, 2019 in the Korean Intellectual Property Office, which is incorporated herein by reference in its entirety as set forth in full.

### BACKGROUND

### 1. Technical Field

Various embodiments of the present disclosure relate to a semiconductor integrated device and, more particularly, to a data storage device, an operation method of the data storage device, and a controller for the data storage device.

### 2. Related Art

A data storage device is electrically coupled to a host device and performs a data input/output operation in response to a request of the host device. The data storage device may use various storage medium for storing data.

The data storage device may be a flash memory device. As storage capacity of a flash memory increases and its price competitiveness improves due to incorporation of improved technology, flash memory devices are increasingly being adopted for use in data centers handling massive data as well as personal computers and a mobile devices.

A flash memory device is incapable of overwrite or in-place update, has a unit of erase operation different from a unit of read/write operation, and has limited program/erase cycles. Therefore, the flash memory device operates to achieve maximum storage capacity and lifespan through a housekeeping operation, such as a wear-levelling operation, a garbage collection operation, a data migration operation, and the like. Therefore, a policy for the housekeeping operation may determine the lifespan of the storage device.

### SUMMARY

In one embodiment of the present disclosure, a data storage device may include: a storage including a plurality of memory blocks, which are divided into a first region configured to operate at a first speed and a second region configured to operate at a lower speed than the first speed; and a controller configured to control the storage, wherein the controller is configured to store information between a plurality of urgency levels, which are defined to classify the storage based on an urgency level determination reference, and a plurality of buffer block groups respectively, being classified on a basis of a number of valid pages included in each of memory blocks within the first region; select a victim block from a buffer block group matched to a current urgency level of the storage; and collect the victim block.

In one embodiment of the present disclosure, a controller for controlling a storage including a plurality of memory blocks, which are divided into a first region configured to operate at a first speed and a second region configured to operate at a lower speed than the first speed, the controller comprising: an urgent level determination component configured to determine an urgency level of the storage based on information between a plurality of urgency levels, which are defined to classify the storage based on an urgency level determination reference, and a plurality of buffer block groups, respectively, being classified on a basis of a number of valid pages included in each of memory blocks within the first region; a block manager configured to group in each of the buffer block groups memory blocks of the first region according to the corresponding valid page range; and a block collector configured to select a victim block from a buffer block group matched to the determined urgency level and collect the victim block.

In one embodiment of the present disclosure, an operating method of a data storage device including a storage including a plurality of memory blocks, which are divided into a first region configured to operate at a first speed and a second region configured to operate at a lower speed than the first speed, and a controller for controlling the storage, the operating method comprising: determining, by the controller, an urgency level of the storage based on information between a plurality of urgency levels, which are defined to classify the storage based on an urgency level determination reference, and a plurality of buffer block groups, respectively, being classified on a basis of a number of valid pages included in each of memory blocks within the first region; configuring, by the controller, each of the buffer block groups by grouping memory blocks of the first region according to the corresponding valid page range; selecting, by the controller, a victim block from a buffer block group matched to the determined urgency level; and collecting, by the controller, the victim block.

In one embodiment of the present disclosure, an operating method of a controller for controlling a storage device including a first region of high-speed memory blocks and a second region of high-capacity memory blocks, the operating method comprising: grouping the memory blocks of the first region into multiple subgroups, each associated with a valid page range, according to a number of valid pages in each memory block of the first region; and controlling the storage device to select a subgroup associated with a lower valid page range, from which to select a victim block, as an urgency level, among multiple urgency levels, of the storage device increases to secure a free memory block.

### BRIEF DESCRIPTION OF THE DRAWINGS

Features, aspects and embodiments are described in conjunction with the attached drawings, in which:

FIG. 1 is a diagram illustrating a configuration of a data storage device in accordance with an embodiment of the present disclosure;

FIG. 2 is a diagram illustrating a physical configuration of a storage in accordance with an embodiment of the present disclosure;

FIG. 3 is a diagram illustrating a logical configuration of a storage in accordance with an embodiment of the present disclosure;

FIG. 4 is a diagram illustrating a configuration of a controller in accordance with an embodiment of the present disclosure;

FIG. 5 is a diagram illustrating a management concept of a storage in accordance with an embodiment of the present disclosure;

FIG. 6 is a diagram illustrating a configuration of a block collector in accordance with an embodiment of the present disclosure;

FIG. 7 is a diagram illustrating an operation of a data storage device in accordance with an embodiment of the present disclosure;

FIG. 8 is a diagram illustrating a data storage system in accordance with an embodiment;

FIG. 9 and FIG. 10 are diagrams illustrating a data processing system in accordance with an embodiment;

FIG. 11 is a diagram illustrating a network system including a data storage device in accordance with an embodiment; and

FIG. 12 is a block diagram illustrating a nonvolatile memory device included in a data storage device in accordance with an embodiment.

### DETAILED DESCRIPTION

A semiconductor apparatus according to the present disclosure is described below with reference to the accompanying drawings through various embodiments. Throughout the specification, reference to “an embodiment” or the like is not necessarily to only one embodiment, and different references to any such phrase are not necessarily to the same embodiment(s).

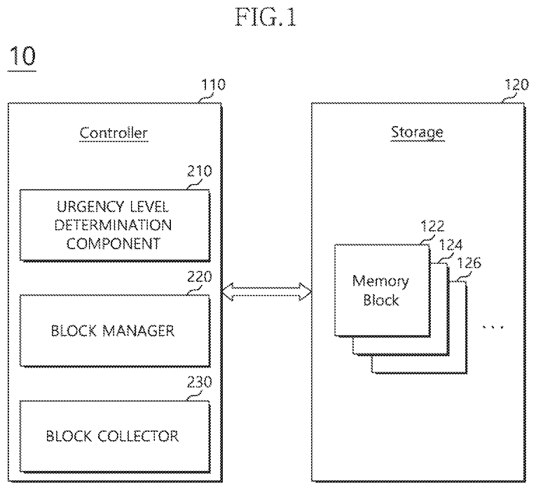

FIG. 1 is a diagram illustrating a configuration of a data storage device in accordance with an embodiment of the present disclosure.

Referring to FIG. 1, the data storage device 10 may include a controller 110 and a storage 120.

The controller 110 may control the storage 120 in response to a host device. For example, the controller 110 may control the storage 120 such that data is programmed into the storage 120 according to a write request of the host device. Also, the controller 110 may provide the host device with data stored in the storage 120 in response to a read request of the host device.

The storage 120 may record data or output recorded data according to control of the controller 110. The storage 120 may include is a volatile or nonvolatile memory device. In an embodiment, the storage 120 may be implemented using any of various nonvolatile memory elements such as the Electrically Erase and Programmable ROM (EEPROM), the NAND flash memory, the NOR flash memory, the Phase change RAM (PRAM), the Resistive RAM (ReRAM), the Ferroelectric RAM (FRAM), the Spin Torque Transfer Magnetic RAM (STT-MRAM) and the like. The storage 120 may include a plurality of dies, or a plurality of chips, or a plurality of packages. Each of the dies, chips, or packages may include a plurality of memory blocks 122, 124 and 123.

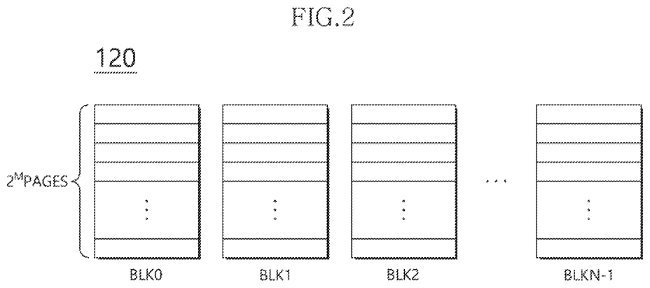

FIG. 2 is a diagram illustrating a physical configuration of a storage in accordance with an embodiment of the present disclosure.

Referring to FIG. 2, the storage 120 may include a plurality of memory blocks, i.e., BLK0 to BLKN-1. Each of the plurality of memory blocks BLK0 to BLKN-1 may include a plurality of pages, for example 2^{M} number of pages.

Each of the plurality of pages may include a plurality of memory cells electrically coupled to a plurality of word lines.

Each of the plurality of memory cells may operate as a Single-Level Cell (SLC) capable of storing one bit or a Multi-Level Cell (MLC) capable of storing, through a multi-levelling technology, a plurality of bits in one memory cell.

The multi-levelling technology is a technology for storing a plurality of bits in one flash memory cell. Because of the multi-levelling technology, there are various X-level cells (XLCs) from the Single-Level Cell to the Quad-Level Cell (QLC) capable of storing four bits. In between, there is a cell capable of storing two bits (sometimes denoted by the general label Multi-Level Cell (MLC)) and a Triple-Level Cell (TLC) capable of storing three bits. As storage capacity of individual memory cells increases, storage capacity of the flash memory also increases, as does the manufacturing cost.

If the XLC storage structure is adopted, where X is greater than 1, storage capacity of a storage may increase X times as compared with using the SLC. However, XLC storage (X is greater than 1) is known to have limitation of relatively lower performance and relatively shorter lifespan as compared with the SLC storage structure. Recently, proposed is a hybrid structure using both SLC and higher level XLC structures in order to overcome the limitation of the XLC storage structure. In the context of comparing the XLC storage structure with the SLC storage structure, X is greater than 1.

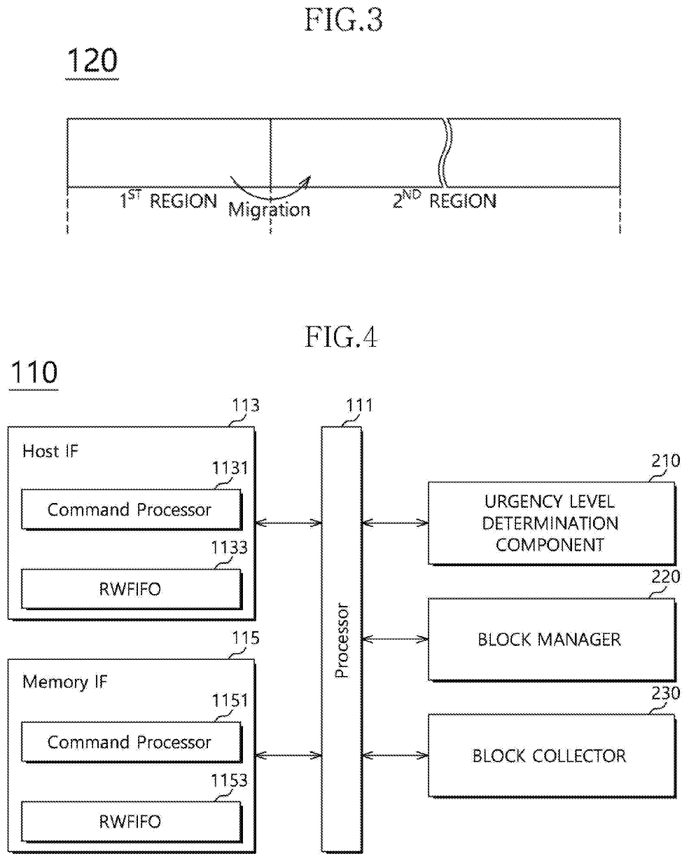

FIG. 3 is a diagram illustrating a logical configuration of a storage in accordance with an embodiment of the present disclosure.

Referring to FIG. 3, the storage 120 may include first and second regions. The first region may be capable of a high-speed operation, which may be through use of SLCs. The second region may be capable of a low-speed operation, which may be and may be through use of XLCs.

In the SLC/XLC hybrid structure as illustrated in FIG. 3, frequently accessed hot data may be written into the first region, which is a SLC region, or the first region may be used as a write buffer, thereby overcoming speed limitation of the XLC. In this case, the storage 120 may show performance at the level of the SLC to a user by firstly storing data, which is input from a host device, into the first region, which has high performance, and then migrating the stored data from the first region into the second region during idle time, during which there is no request from the host device. However, when the SLC region is part of the storage 120, there may be additional overhead in migrating data stored in the SLC region into the XLC region.

As such, in a hybrid storage using a SLC region as a write buffer, data stored in the SLC region should be migrated into the XLC region in order to persistently provide write performance at the level of the SLC region.

A migration operation may include reading data from the SLC region and an operation of writing the read data into the XLC region.

Therefore, in a situation of a heavy workload in which there is insufficient idle time to perform the migration operation, data stored in the SLC buffer cannot be migrated and thus data is directly stored in the XLC region. Therefore, a data storage device operates with write performance of the XLC structure.

For data migration to occur without affecting performance of a system, a block having a least number of valid pages among closed blocks storing data which can be migrated, in the SLC region may be selected as a victim block. However, because a flash memory device is not capable of over-write, a frequently accessed block, i.e., a hot block, may have a high likelihood of being logically over-written a high is number of times and thus is likely to have a high number of invalid pages. That is, there is a high probability that a hot block is selected as a victim block.

Therefore, when selecting a victim block for an internal operation including an operation of moving data such as a migration operation, a garbage collection operation and the like based on a least number of valid pages, it may be hard to collect a SLC block storing cold data.

Therefore, the controller 1.10 in accordance with an embodiment of the present invention may determine an urgency level for an operation of moving data in the storage 120 according to a status and/or a workload of the storage 120, and may configure a plurality of buffer block groups by grouping memory blocks configuring the first region based on a number of valid pages. Also, the controller 110 may perform an operation of moving data by selecting a victim block from a buffer block group among the plurality of buffer block groups according to the status or the workload of the storage 120.

Referring back to FIG. 1, the controller 110 may include an urgent level determination component 210, a block manager 220 and a block collector 230.

The urgent level determination component 210 may be configured to determine an urgency level of a data moving operation of the storage 120 based on an urgency level determination reference and usage status of the storage 120. The urgency level determination reference may be predetermined.

In an embodiment, the urgency level determination reference may be set according to a number of free blocks included in the second region of the storage 120, speed of data input from a host device and lifespan of the storage 120.

In a case in which the urgency level determination reference is set according to the number of free blocks in the second region, a plurality of urgency levels may be determined according to a number of free blocks and the urgency level of the storage 120 may be determined according to the number of the free blocks included in the storage 120. In this case, i.e., when multiple urgency levels correspond to the same number of free blocks, the urgency level may be differently set according to an operation status of the storage 120, for example according to whether the storage 120 is in an idle state or in an active state. For example, even when the storage 120 has the same number of free blocks, the storage 120 in the active status may be determined to have a higher urgency level than the storage 120 in the idle status.

In a case in which the urgency level determination reference is set according to the speed of data input from a host device, a plurality of urgency levels may be determined according to the speed of data input from a host device and the urgency level of the storage 120 may be determined according to an actual speed of data input from a host device.

In a case in which the urgency level determination reference is set according to the lifespan of the storage 120, a plurality of urgency levels may be determined according to a reference to determine the lifespan of the storage 120, for example numbers of erase/write operations of the storage 120, and the urgency level of the storage 120 may be determined according to remaining life of the storage 120.

The block manager 220 may store, update and erase characteristic information about each memory block in the first region and the second region of the storage 120, for example information of a level (SLC/XLC) of a physical address of each memory block, a status (closed, open, free, bad and the like) of each memory block, a purpose (data, firmware, overprovisioning, and the like) of each memory block, characteristics (valid and invalid) of pages configuring each memory block. Also, the block manager 220 may manage a number of valid pages included in each memory block configuring the first region and the second region based on the characteristic information about each memory block.

In an embodiment, the block manager 220 may update the characteristic information about a memory block when the memory block is allocated or released or when a characteristic of the memory block is changed.

The block manager 220 may configure at least one buffer block group by grouping memory blocks configuring the first region based on a number of valid pages (VPSB). In an embodiment, at least one reference range may be set according to a number of valid pages, and memory blocks having numbers of valid pages falling within reference ranges may be respectively grouped.

The block collector 230 may store matching information between an urgency level and a buffer block group of the storage 120. Also, the block collector 230 may select a buffer block group matched to an urgency level of the storage 120, the urgency level being determined by the urgent level determination component 210, and may select a memory block as a victim block among memory blocks in the selected buffer block group. Also, the block collector 230 may control the storage 120 to perform a block collection operation by copying data stored in the victim block into a target block. For example, the block collection operation may be a migration operation or a garbage collection operation. In an embodiment, the migration operation for the block collection may include moving data from the first region to the second region and the garbage collection operation may be performed on the first region.

In an embodiment, the block collector 230 may match an urgency level and a buffer block group such that a victim block is selected preferentially from a buffer block group having a smaller number of valid pages as the urgency level becomes higher.

In an embodiment, in a situation of the highest urgency level, such as for example when a number of free blocks remaining in the storage 120 is extremely low, when the speed of data input from a host device is very high, or when the storage 120 reaches its end-of-life, all memory blocks included in all buffer block groups may be candidates for a victim block and the storage 120 may be controlled to select a memory block having the least number of valid pages as a victim block among all memory blocks in all buffer block groups.

In a situation of an urgency level lower than the highest urgency level, the block collector 230 may control the storage 120 to perform an operation of moving data stored in a victim block, which is selected from a buffer block group according to the urgency level, to the second region.

In accordance with an embodiment of the present disclosure, only data of a memory block having a least number of valid pages within the first region may be moved to the second region according to the urgency level of securing a free block in the first region. Therefore, data may be moved at high speed with low cost and without affecting performance of the data storage device 10 and thus a free block may be secured at a high speed.

FIG. 4 is a diagram illustrating a configuration of a controller in accordance with an embodiment of the present disclosure.

Referring to FIG. 4, the controller 110 may include a processor 111, a host interface 113, a memory interface 115, the urgent level determination component 210, the block manager 220 and the block collector 230.

The processor 111 may be configured to provide the host interface 113, the memory interface 115, the urgent level determination component 210, the block manager 220 and the block collector 230 with various control information for a data read or write operation on the storage 120. In an embodiment, the processor 111 may be a central processing unit (CPU) and may operate according to firmware provided for various operations of the data storage device 10.

In an embodiment, the processor 111 may be configured to perform a function of a flash translation layer (FTL) for performing operations of the garbage collection, the address mapping, the wear-levelling and the like for managing the storage 120, a function of detecting and correcting an error of data read from the storage 120 and the like.

The host interface 113 may be configured to receive a command and a clock signal from a host device and may provide a communication channel for controlling input/output of data, according to control of the processor 111. Especially, the host interface 113 may provide physical connection between a host device and the data storage device 10. Also, the host interface 113 may provide interfacing to the data storage device 10 according to a bus format of a host device. The bus format of a host device may include at least one among standard interface protocols, such as the secure digital, the universal serial bus (USB), the multi-media card (MMC), the embedded MMC (eMMC), the personal computer memory card international association (PCMCIA), the parallel advanced technology attachment (DATA), the serial advanced technology attachment (SATA), the small computer system interface (SCSI), the serial attached SCSI (SAS), the peripheral component interconnection (PCI), the PCI Express (PCI-E) and the universal flash storage (UFS).

The host interface 113 may include a command processor 1131 and a first input/output buffer (RWFIFO) 1133.

The command processor 1131 may queue a command provided from a host device, schedule a processing order of the queued command and sequentially providing the processor 111 with the scheduled command.

The first input/output buffer 1133 may temporarily store write data provided from a host device and may temporarily store read data read from the storage 120.

The memory interface 115 may provide a communication channel for transmitting/receiving a signal between the controller 110 and the storage 120.

The memory interface 115 may include a command processor 1151 and a second input/output buffer (RWFIFO) 1153.

The command processor 1151 may provide a control signal to the storage 120 based on a command provided from the processor 111.

The second input/output buffer 1153 may temporarily store write data provided in a write operation and may temporarily store read data read from the storage 120 in a read operation, according to control of the processor 111.

The urgent level determination component 210 may be configured to determine an urgency level of a data moving operation of the storage 120 based on an urgency level determination reference and usage status of the storage 120.

In an embodiment, the urgency level determination reference may be set according to a number of free blocks included in the second region of the storage 120, speed of data input from a host device and remaining life of the storage 120.

In a case in which the urgency level determination reference is set according to the number of free blocks in the second region, at least one threshold range may be determined according to a number of free blocks and the urgency level of the storage 120 may be determined according to the number of the free blocks included in the storage 120. In this case, the urgency level may be differently set according to an operation status of the storage 120, for example according to whether the storage 120 is in an idle state or in an active state. For example, even when the storage 120 has the same number of free blocks, the storage 120 in the active status may be determined to have a higher urgency level than the storage 120 in the idle status.

In a case in which the urgency level determination reference is the speed of data input from a host device, at least one threshold range may be predetermined according to the speed of data input from a host device and the urgency level of the storage 120 may be determined according to an actual speed of data input from a host device.

In a case in which the urgency level determination reference is set according to the remaining life of the storage 120, at least one threshold range may be predetermined according to a reference to determine the lifespan of the storage 120, for example numbers of erase/write operations of the storage 120, and the urgency level of the storage 120 may be determined according to remaining life of the storage 120.

The block manager 220 may store, update and erase characteristic information about each memory block included in the first region and the second region of the storage 120, for example information of a level (SLC/XLC) of physical address of each memory block, a status (closed, open, free, bad and the like) of each memory block, a purpose (data, firmware, overprovisioning, and the like) of each memory block, characteristics (valid and invalid) of pages configuring each memory block. Also, the block manager 220 may manage a number of valid pages in each memory block configuring the first region and the second region based on the characteristic information about each memory block.

The block manager 220 may configure at least one buffer block group by grouping memory blocks configuring the first region based on a number of valid pages. In an embodiment, at least one reference range may be set according to a number of valid pages and memory blocks having numbers of valid pages falling within reference ranges may be respectively grouped.

The block collector 230 may store matching information between an urgency level and a buffer block group of the storage 120. Also, the block collector 230 may select a buffer block group matched to an urgency level of the storage 120, the urgency level being determined by the urgent level determination component 210, and may select a memory block as a victim block among memory blocks in the selected buffer block group. Also, the block collector 230 may control the storage 120 to perform a block collection operation by moving data stored in the victim block into a target block. For example, the block collection operation may be the data migration operation or the garbage collection operation.

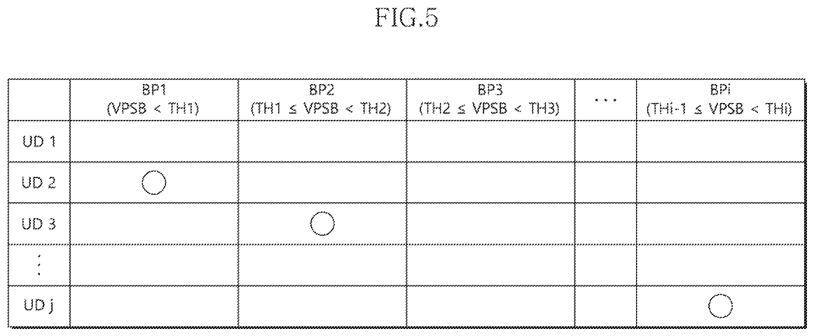

FIG. 5 is a diagram illustrating a management concept of a storage in accordance with an embodiment of the present disclosure.

Referring to FIG. 5, the urgent level determination component 210 may be configured to determine urgency levels UD1 to UDj of a data moving operation of the storage 120 based on an urgency level determination reference and usage status of the storage 120.

In an embodiment, the block manager 220 may set various reference ranges, for example, VPSB<TH1, TH1≤VPSB<TH2, TH2≤VPSB<TH3, . . . , THi−1≤VPSB<THi according to a number of valid pages VPSB, and may group memory blocks having VPSBs falling within the reference ranges, respectively.

Also, the block collector 230 may store information matching buffer block groups BP1 to Bpi to respective urgency levels UD1 to UDj of the storage 120.

In an embodiment, in a situation of the highest urgency level, i.e., UD1, all memory blocks in all buffer block groups may be set as victim block candidates. In an embodiment, in a situation of the highest urgency level, such as when a number of free blocks remaining in the storage 120 is extremely small, when the speed of data input from a host device is very high, or when the storage 120 reaches its end-of-life, all memory blocks in all buffer block groups may be victim block candidates and the storage 120 may be controlled to select a memory block having the least number of valid pages as a victim block.

In a situation of urgency levels UD2 to USj lower than the highest urgency level UD1, a buffer block group may be matched such that a victim block is selected from the buffer block group having valid pages, a number of which can minimize data moving cost.

According to another aspect of the present invention, the block collector 230 may match an urgency level and a buffer block group such that a victim block is selected preferentially from a buffer block group having a smaller number of valid pages as the urgency level of the storage 120 becomes higher.

In a situation of an urgency level lower than the highest urgency level, the block collector 230 may control the storage 120 to perform an operation of moving data stored in a victim block, which is selected from a buffer block group according to the urgency level, to the second region.

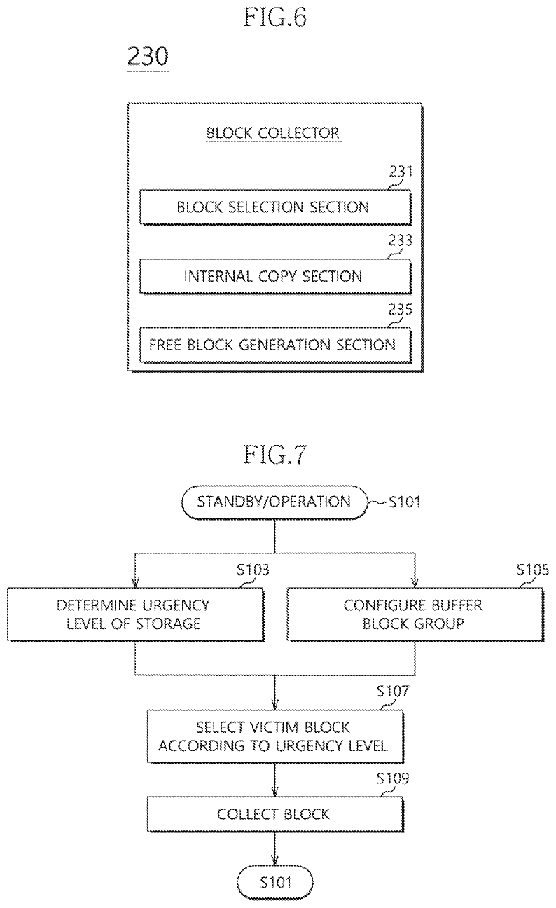

FIG. 6 is a diagram illustrating a configuration of a block collector in accordance with an embodiment of the present disclosure.

Referring to FIG. 6, the block collector 230 may include a block selection section 231, an internal copy section 233 and a free block generation section 235.

The block selection section 231 may select, based on the urgency level of the storage 120 determined by the urgent level determination component 210 and the information matching the buffer block groups BP1 to Bpi to respective urgency levels UD1 to UDj of the storage 120, at least one buffer block group matched to the determined urgency level. Also, the block selection section 231 may select any of the memory blocks in the selected at least one buffer block group as a victim block. The block selection section 231 may select a target block, into which valid pages in the victim block are to be copied.

The internal copy section 233 may move data, which is selected in the victim block by the block selection section 231, to the target block.

The free block generation section 235 may generate a free block by erasing the victim block after the data of the victim block is moved to the target block.

Accordingly, a free block may be secured in the first region, which operates at a relatively higher speed than the second region, and the data storage device 10 may perform a high-speed operation with overall performance commensurate with that of the first region.

FIG. 7 is a diagram illustrating an operation of a data storage device in accordance with an embodiment of the present disclosure.

After the data storage device 10 is powered on, booted and initialized, the data storage device 10 may be on standby or may perform an operation according to a request from a host device (S101).

The controller 110 may determine an urgency level of a data moving operation of the storage 120 based on an urgency level determination reference and usage status of the storage 120 (S103).

In an embodiment, the urgency level determination reference may include a number of free blocks included in the second region of the storage 120, speed of data input from a host device and a remaining life of the storage 120.

The controller 110 may manage characteristic information about each memory block in the first region configured to operate at a first speed and the second region configured to operate at a lower speed than the first speed. Also, based on such characteristic information, the controller 110 may configure at least one buffer block group by grouping memory blocks configuring the first region based on a number of valid pages (S105). In an embodiment, at least one reference range may be set according to a number of valid pages and memory blocks having numbers of valid pages falling within reference ranges may be respectively grouped.

The controller 110 may store matching information between an urgency level and a corresponding buffer block group of the storage 120. The controller 110 may select a buffer block group matched to an urgency level of the storage 120, the urgency level being determined at step S103, and may select a memory block as a victim block among memory blocks in the selected buffer block group (S107).

Also, the controller 110 may control the storage 120 to perform a block collection operation by moving data stored in the victim block into a target block (S109). For example, the block collection operation may be a data migration operation or a garbage collection operation.

For the block collection operation (S109) through data move, the controller 110 may select as a target block any of the memory blocks in the second region. Also, the controller 110 may acquire a free block by erasing the victim block after copying data stored in the victim block selected at step S107 into the target block.

For the block collection operation (S109) through the garbage collection operation, the controller 110 may select as a target block any of the memory blocks in the first region. Also, the controller 110 may acquire a free block by erasing the victim block after copying data stored in the victim block selected at step S107 into the target block. After step S109, the controller goes back to standby/operation and repeats the process S101 to S109.

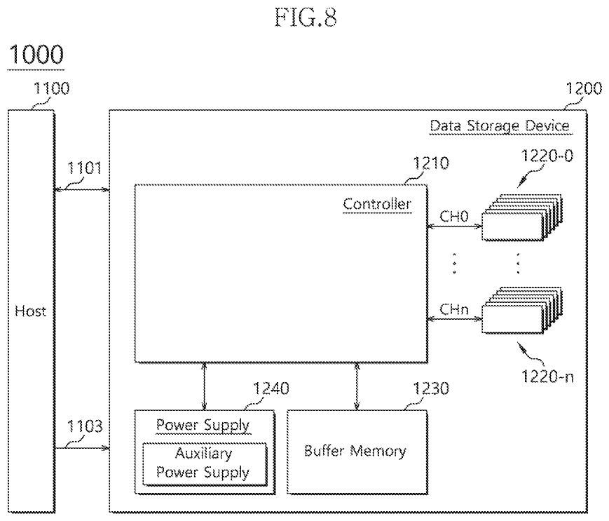

FIG. 8 is a diagram illustrating a data storage system 1000 in accordance with an embodiment.

Referring to FIG. 8, the data storage 1000 may include a host device 1100 and the data storage device 1200. In an embodiment, the data storage device 1200 may be configured as a solid state drive (SSD).

The data storage device 1200 may include a controller 1210, a plurality of nonvolatile memory devices 1220-0 to 1220-n, a buffer memory device 1230, a power supply 1240, a signal connector 1101, and a power connector 1103.

The controller 1210 may control general operations of the data storage device 1200. The controller 1210 may include a host interface, a controller, a random access memory used as a working memory, an error correction code (ECC) circuit, and a memory interface. In an embodiment, the controller 1210 may configured as controller 110 shown in FIGS. 1 and 2.

The host device 1100 may exchange a signal with the data storage device 1200 through the signal connector 1101. The signal may include a command, an address, data, and the like.

The controller 1210 may analyze and process the signal received from the host device 1100. The controller 1210 may control operations of internal function blocks according to firmware or software for driving the data storage device 1200.

The buffer memory device 1230 may temporarily store data to be stored in at least one of the nonvolatile memory devices 1220-0 to 1220-n. Further, the buffer memory device 1230 may temporarily store the data read from at least one of the nonvolatile memory devices 1220-0 to 1220-n. The data temporarily stored in the buffer memory device 1230 may be transmitted to the host device 1100 or at least one of the nonvolatile memory devices 1220-0 to 1220-n according to control of the controller 1210.

The nonvolatile memory devices 1220-0 to 1220-n may be used as storage media of the data storage device 1200. The nonvolatile memory devices 1220-0 to 1220-n may be coupled with the controller 1210 through a plurality of channels CH0 to CHn, respectively. One or more nonvolatile memory devices may be coupled to one channel. The nonvolatile memory devices coupled to the same channel may be coupled to the same signal bus and data bus.

The power supply 1240 may provide power inputted through the power connector 1103 to the controller 1210, the nonvolatile memory devices 1220-0 to 1220-n and the buffer memory device 1230 of the data storage device 1200. The power supply 1240 may include an auxiliary power supply. The auxiliary power supply may supply power to allow the data storage device 1200 to be properly terminated when a sudden power interruption occurs. The auxiliary power supply may include bulk-capacity capacitors sufficient to store the needed charge.

The signal connector 1101 may be configured as any of various types of connectors depending on an interface scheme between the host device 1100 and the data storage device 1200.

The power connector 1103 may be configured as any of various types of connectors depending on a power supply scheme of the host device 1100.

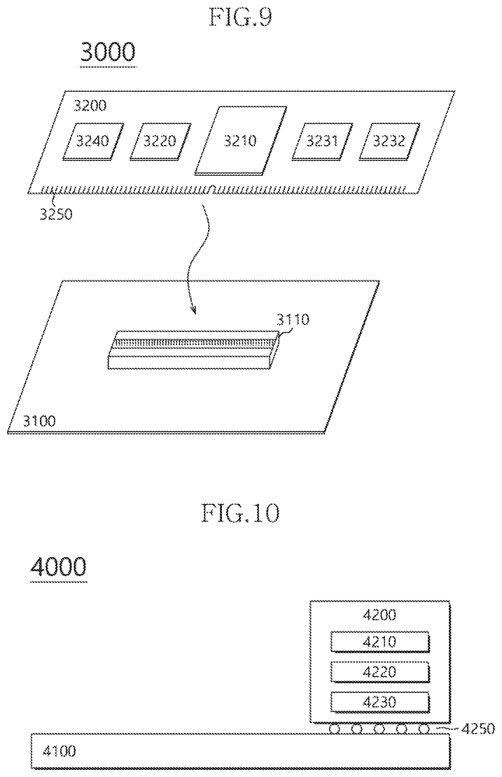

FIG. 9 is a diagram illustrating a data processing system 3000 in accordance with an embodiment. Referring to FIG. 9, the data processing system 3000 may include a host device 3100 and a memory system 3200.

The host device 3100 may be configured in the form of a board, such as a printed circuit board. Although not shown, the host device 3100 may include internal function blocks for performing the function of a host device.

The host device 3100 may include a connection terminal 3110, such as a socket, a slot, or a connector. The memory system 3200 may be mated to the connection terminal 3110.

The memory system 3200 may be configured in the form of a board, such as a printed circuit board. The memory system 3200 may be referred to as a memory module or a memory card. The memory system 3200 may include a controller 3210, a buffer memory device 3220, nonvolatile memory devices 3231 and 3232, a power management integrated circuit (PMIC) 3240, and a connection terminal 3250.

The controller 3210 may control general operations of the memory system 3200. The controller 3210 may be configured in the same manner as the controller 110 shown in FIGS. 1 and 2.

The buffer memory device 3220 may temporarily store data to be stored in the nonvolatile memory devices 3231 and 3232. Further, the buffer memory device 3220 may temporarily store data read from the nonvolatile memory devices 3231 and 3232. The data temporarily stored in the buffer memory device 3220 may be transmitted to the host device 3100 or the nonvolatile memory devices 3231 and 3232 according to control of the controller 3210.

The nonvolatile memory devices 3231 and 3232 may be used as storage media of the memory system 3200.

The PMIC 3240 may provide the power inputted through the connection terminal 3250 to the inside of the memory system 3200. The PMIC 3240 may manage the power of the memory system 3200 according to control of the controller 3210.

The connection terminal 3250 may be coupled to the connection terminal 3110 of the host device 3100. Through the connection terminal 3250, signals such as commands, addresses, data, and the like, as well as power may be transferred between the host device 3100 and the memory system 3200. The connection terminal 3250 may be configured as any of various types depending on an interface scheme between the host device 3100 and the memory system 3200. The connection terminal 3250 may be disposed on a side of the memory system 3200, as shown.

FIG. 10 is a diagram illustrating a data processing system 4000 in accordance with an embodiment. Referring to FIG. 10, the data processing system 4000 may include a host device 4100 and a memory system 4200.

The host device 4100 may be configured in the form of a board, such as a printed circuit board. Although not shown, the host device 4100 may include internal function blocks for performing the function of a host device.

The memory system 4200 may be configured in the form of a surface-mounted type package. The memory system 4200 may be mounted to the host device 4100 through solder balls 4250. The memory system 4200 may include a controller 4210, a buffer memory device 4220, and a nonvolatile memory device 4230.

The controller 4210 may control general operations of the memory system 4200. The controller 4210 may be configured in the same manner as the controller 110 shown in FIGS. 1 and 2.

The buffer memory device 4220 may temporarily store data to be stored in the nonvolatile memory device 4230. Further, the buffer memory device 4220 may temporarily store data read from the nonvolatile memory device 4230. The data temporarily stored in the buffer memory device 4220 may be transmitted to the host device 4100 or the nonvolatile memory device 4230 according to control of the controller 4210.

The nonvolatile memory device 4230 may be used as the storage medium of the memory system 4200.

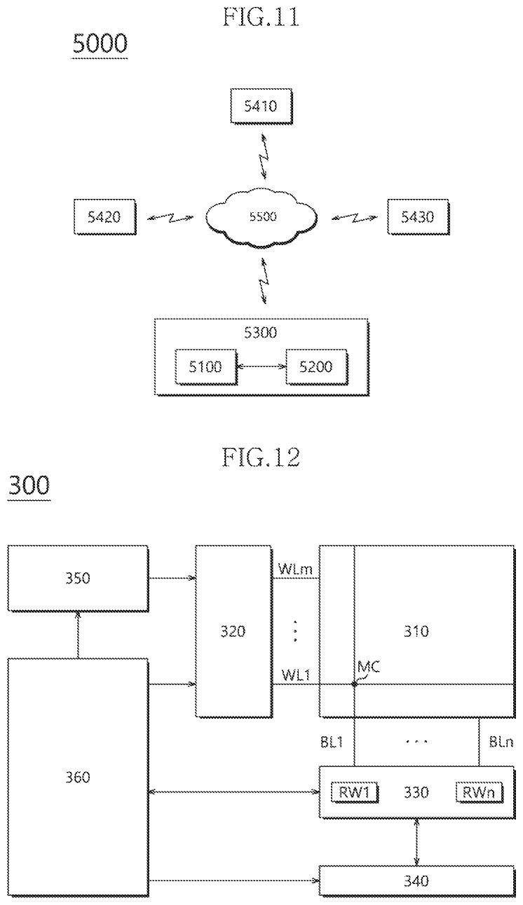

FIG. 11 is a diagram illustrating a network system 5000 including a data storage device, in accordance with an embodiment. Referring to FIG. 11, the network system 5000 may include a server system 5300 and a plurality of client systems 5410, 5420, and 5430, which are coupled through a network 5500.

The server system 5300 may service data in response to requests from the plurality of client systems 5410 to 5430. For example, the server system 5300 may store the data provided by the plurality of client systems 5410 to 5430. For another example, the server system 5300 may provide data to the plurality of client systems 5410 to 5430.

The server system 5300 may include a host device 5100 and a memory system 5200. The memory system 5200 may be configured as the memory system 10 shown in FIG. 1, the data storage device 1200 shown in FIG. 8, the memory system 3200 shown in FIG. 9, or the memory system 4200 shown in FIG. 10.

FIG. 12 is a block diagram illustrating a nonvolatile memory device 300 included in a data storage device, such as the data storage device 10, in accordance with an embodiment. Referring to FIG. 12, the nonvolatile memory device 300 may include a memory cell array 310, a row decoder 320, a data read/write block 330, a column decoder 340, a voltage generator 350, and control logic 360.

The memory cell array 310 may include memory cells MC which are arranged at areas where word lines WL1 to WLm and bit lines BL1 to BLn intersect with each other.

The memory cell array 310 may comprise a three-dimensional memory array. The three-dimensional memory array, for example, has a stacked structure extending perpendicular direction to the flat surface of a semiconductor substrate. Moreover, the three-dimensional memory array means a structure including NAND strings of which memory cells are stacked perpendicular to the flat surface of a semiconductor substrate.

The structure of the three-dimensional memory array is not limited to the embodiment indicated above. The memory array structure can be formed in a highly integrated manner with horizontal directionality as well as vertical directionality. In an embodiment, in the NAND strings of the three-dimensional memory array, memory cells are arranged in both parallel and perpendicular to the surface of the semiconductor substrate. The memory cells may be variously spaced to provide different degrees of integration.

The row decoder 320 may be coupled with the memory cell array 310 through the word lines WL1 to WLm. The row decoder 320 may operate according to control of the control logic 360. The row decoder 320 may decode an address provided by an external device (not shown). The row decoder 320 may select and drive the word lines WL1 to WLm, based on a decoding result. For instance, the row decoder 320 may provide a word line voltage, provided by the voltage generator 350, to the word lines WL1 to WLm.

The data read/write block 330 may be coupled with the memory cell array 310 through the bit lines BL1 to BLn. The data read/write block 330 may include read/write circuits RW1 to RWn, respectively, corresponding to the bit lines BL1 to BLn. The data read/write block 330 may operate according to control of the control logic 360. The data read/write block 330 may operate as a write driver or a sense amplifier, according to an operation mode. For example, the data read/write block 330 may operate as a write driver, which stores data provided by the external device in the memory cell array 310 in a write operation. For another example, the data read/write block 330 may operate as a sense amplifier, which reads out data from the memory cell array 310 in a read operation. [00133]The column decoder 340 may operate according to control of the control logic 360. The column decoder 340 may decode an address provided by the external device. The column decoder 340 may couple the read/write circuits RW1 to RWn of the data read/write block 330, respectively corresponding to the bit lines BL1 to BLn, with data input/output lines or data input/output buffers, based on a decoding result.

The voltage generator 350 may generate voltages to be used in internal operations of the nonvolatile memory device 300. The voltages generated by the voltage generator 350 may be applied to the memory cells of the memory cell array 310. For example, a program voltage generated in a program operation may be applied to a word line of memory cells for which the program operation is to be performed. For another example, an erase voltage generated in an erase operation may be applied to a well area of memory cells for which the erase operation is to be performed. For still another example, a read voltage generated in a read operation may be applied to a word line of memory cells for which the read operation is to be performed. [00135]The control logic 360 may control general operations of the nonvolatile memory device 300, based on control signals provided by the external device. For example, the control logic 360 may control operations of the nonvolatile memory device 300 such as read, write, and erase operations of the nonvolatile memory device 300.

While various embodiments have been illustrated and described, it will be understood by those skilled in the art that the embodiments described are examples only. Accordingly, the present invention is not limited by or to the described embodiments. Rather, the present invention encompasses all modifications and variations of any of the disclosed embodiments that fall within the scope of the claims.

What is claimed is:

1. A data storage device comprising:
a storage including a plurality of memory blocks, which are divided into a first region configured to operate at a first speed and a second region configured to operate at a lower speed than the first speed; and
a controller configured to control the storage,
wherein the controller is configured to:
store information between a plurality of urgency levels, which are defined to classify the storage based on an urgency level determination reference, and a plurality of buffer block groups respectively, being classified on a basis of a number of valid pages included in each of memory blocks within the first region;
select a victim block from a buffer block group matched to a current urgency level of the storage; and
collect the victim block.

2. The data storage device of claim 1, wherein the controller is configured to select, as the victim block, any memory block of the buffer block group matched to the current urgency level.

3. The data storage device of claim 1,
wherein the urgency level determination reference includes a number of free blocks, and wherein the controller is configured to determine an urgency level of the storage according to a number of free blocks in the second region.

4. The data storage device of claim 3, wherein the urgency level determination reference further includes an operation status indicating whether the storage is in an idle state or in an active state.

5. The data storage device of claim 1,
wherein the urgency level determination reference includes speed of data input, and
wherein the controller is configured to determine an urgency level of the storage according to the speed of data input from a host device to the storage.

6. The data storage device of claim 1,
wherein the urgency level determination reference includes a lifespan of the storage, and
wherein the controller is configured to determine an urgency level of the storage according to a remaining life of the storage.

7. The data storage device of claim 1, wherein the controller is configured to collect the victim block through a data migration operation or a garbage collection operation.

8. The data storage device of claim 7, wherein the data migration operation includes copying data stored in the victim block into a target block selected from the second region.

9. The data storage device of claim 7, wherein the garbage collection operation includes copying data stored in the victim block into a target block selected from the first region.

10. The data storage device of claim 1, wherein the first region is a group of memory blocks comprising single-level cells each configured to store one bit of data therein.

11. The data storage device of claim 1, wherein the second region is a group of memory blocks comprising multi-level cells each configured to store multiple bits of data therein.

12. A controller for controlling a storage including a plurality of memory blocks, which are divided into a first region configured to operate at a first speed and a second region configured to operate at a lower speed than the first speed, the controller comprising:
an urgent level determination component configured to determine an urgency level of the storage based on information between a plurality of urgency levels, which are defined to classify the storage based on an urgency level determination reference, and a plurality of buffer block groups, respectively, being classified on a basis of a number of valid pages included in each of memory blocks within the first region;
a block manager configured to group in each of the buffer block groups memory blocks of the first region according to the corresponding valid page range; and
a block collector configured to select a victim block from a buffer block group matched to the determined urgency level and collect the victim block.

13. The controller of claim 12, wherein the block collector is configured to select, as the victim block, any memory block of the buffer block group matched to the determined urgency level.

14. The controller of claim 12,
wherein the urgency level determination reference includes a number of free blocks, and
wherein the urgent level determination component is configured to determine the urgency level of the storage according to a number of free blocks included in the second region.

15. The controller of claim 14, wherein the urgency level determination reference further includes an operation status indicating whether the storage is in an idle state or in an active state.

16. The controller of claim 12,
wherein the urgency level determination reference includes speed of data input, and
wherein the urgent level determination component is configured to determine the urgency level of the storage according to the speed of data input from a host device to the storage.

17. The controller of claim 12,
wherein the urgency level determination reference includes a lifespan of the storage, and
wherein the urgent level determination component is configured to determine the urgency level of the storage according to a remaining life of the storage.

18. The controller of claim 12, wherein the block collector is configured to collect the victim block by copying data stored in the victim block into a target block selected from the second region.

19. The controller of claim 12, wherein the block collector is configured to collect the victim block by copying data stored in the victim block into a target block selected from the first region.

20. The controller of claim 12, wherein the first region is a group of memory blocks comprising single-level cells each configured to store one bit of data therein, and the second region is a group of memory blocks comprising multi-level cells each configured to store multiple bits of data therein.

21. An operating method of a data storage device including a storage including a plurality of memory blocks, which are divided into a first region configured to operate at a first speed and a second region configured to operate at a lower speed than the first speed, and a controller for controlling the storage, the operating method comprising:
determining, by the controller, an urgency level of the storage based on information between a plurality of urgency levels, which are defined to classify the storage based on an urgency level determination reference, and a plurality of buffer block groups, respectively, being classified on a basis of a number of valid pages included in each of memory blocks within the first region;
configuring, by the controller, each of the buffer block groups by grouping memory blocks of the first region according to the corresponding valid page range;
selecting, by the controller, a victim block from a buffer block group matched to the determined urgency level; and
collecting, by the controller, the victim block.

22. The operating method of claim 21, wherein the selecting of the victim block includes randomly selecting, as the victim block, any memory block of the buffer block group matched to the determined urgency level.

23. The operating method of claim 21,
wherein the urgency level determination reference includes a number of free blocks, and
wherein the determining of the urgency level includes determining the urgency level of the storage according to a number of free blocks included in the second region.

24. The operating method of claim 23, wherein the urgency level determination reference further includes an operation status indicating whether the storage is in an idle state or in an active state.

25. The operating method of claim 21,
wherein the urgency level determination reference includes speed of data input, and
wherein the determining of the urgency level includes determining the urgency level of the storage according to the speed of data input from a host device to the storage.

26. The operating method of claim 21,
wherein the urgency level determination reference includes a lifespan of the storage, and
wherein the determining of the urgency level includes determining the urgency level of the storage according to a remaining life of the storage.

27. The operating method of claim 21, wherein the collecting of the victim block includes copying data stored in the victim block into a target block selected from the second region.

28. The operating method of claim 21, wherein the collecting of the victim block includes copying data stored in the victim block into a target block selected from the first region.

29. The operating method of claim 21, wherein the first region is a group of memory blocks comprising single-level cells each configured to store one bit of data therein, and the second region is a group of memory blocks comprising multi-level cells each configured to store multiple bits of data therein.

30. An operating method of a controller for controlling a storage device including a first region of high-speed memory blocks and a second region of high-capacity memory blocks, the operating method comprising:
grouping the memory blocks of the first region into multiple subgroups, each associated with a valid page range, according to a number of valid pages in each memory block of the first region; and
controlling the storage device to select a subgroup associated with a lower valid page range, from which to select a victim block, as an urgency level, among multiple urgency levels, of the storage device increases to secure a free memory block.
